(19) United States
(12) Patent Application Publication
(10) Pub. No.: US 2003/0224766 A1
(43) Pub. Date: Dec. 4, 2003

(54) Method and system for chargeable or authorized parking

(76) Inventor: Rudolf Stockhammer, St. Gilgen (AT)

Correspondence Address: FLYNN THIEL BOUTELL & TANIS, P.C., 2026 RAMBLING ROAD, KALAMAZOO, MI, 49008-1699, US

(21) Appl. No.: 10/410,571

(22) Filed: Apr. 9, 2003

(30) Foreign Application Priority Data
Apr. 10, 2002 (EP) 02 008 024.8

(51) Int. Cl. H04M 3/42

(52) U.S. Cl. 455/414.1; 455/415; 455/575.9

(57) ABSTRACT

For chargeable or authorized parking of a vehicle in a traffic zone, the vehicle carries a terminal (7) with identification data for noncontacting data communication with transmitting and/or receiving devices (10, 11, 13). The terminal (7) has a user interface (21) with at least two keys and information reporting means (17). After the identification data are read with a transmitting and/or receiving device (10) at the entrance (1), the blocking device (3) is opened. When the traffic zone is left, the identification data are read again with a transmitting and/or receiving device (11) at the exit (4), the blocking device (6) at the exit (4) being opened in case of ensured payment or of authorization.

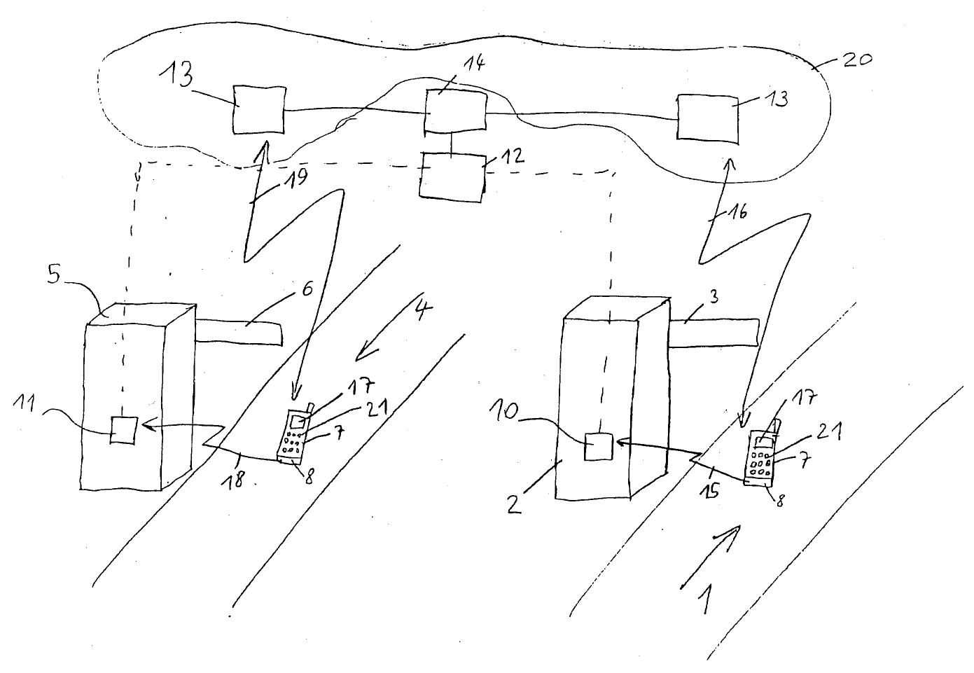

This invention relates to a method and system for chargeable or authorized parking of a vehicle in a traffic zone.

For chargeable parking of a vehicle in a parking facility, such as a parking lot, parking garage or similar traffic zone, whose use is chargeable or requires authorization, the driver must perform a plurality of transactions nowadays. Thus, for long-term parking a contract is usually made, whereupon the long-term parker receives a ticket with which he can actuate the barrier or other block at the entrance and exit. The ticket must be sent by mail or picked up. Moreover, it is necessary to open the windows of an automobile at the entrance and exit to actuate the block with the ticket. For short-term parkers, tickets or tokens or the like are used that additionally require a payment process with a cashier before actuation of the block at the exit. Moreover, tickets or tokens can be easily misplaced.

The problem of the invention is to substantially simplify chargeable or authorized parking.

This problem is solved according to the invention with the method characterized in claim 1. Advantageous embodiments of the inventive method are stated in claims 2 to 15. Claim 16 relates to a system for carrying out the inventive method.

According to the invention, the vehicle has, for chargeable or authorized parking, a terminal with identification data for noncontacting data communication with transmitting and/or receiving devices of the traffic zone. The terminal has a user interface with at least two keys and information reporting means, for example a display and/or voice output device.

The terminal can be firmly installed in the vehicle or mobile. A mobile terminal can be in particular a mobile phone. The noncontacting communication with the transmitting and/or receiving devices of the traffic zone makes it unnecessary to open the window of the car or other automobile when parking. The traffic zone can be a parking garage, a parking lot or another traffic space for parking vehicles whose use is chargeable or requires authorization.

The entrance, or, if the traffic zone has a plurality of entrances, each entrance, is provided with a transmitting and/or receiving device that reads the identification data of the terminal. Then the block at the entrance is opened and the entrance data are stored for example so as to be retrievable by the terminal.

As at the entrance, or each entrance, a receiving device is also provided at the exit, or each exit, of the traffic zone for reading the identification data when the traffic zone is left. When it is ensured that the fee accrued for the parking time is or will be paid, or parking authorization exists, the block at the exit is opened.

The block at the, or each, entrance and exit can be a barrier, gate, traffic light or similar device. If the block is a barrier, the transmitting and/or receiving device can be disposed in the parking post associated with the barrier.

The entrance data, which are stored e.g. so as to be retrievable by the terminal, are in particular the entrance time, i.e. the time and optionally date. Moreover, if the traffic zone has a plurality of entrances the particular entrance used, specified by a number, street name or the like, can be included in the entrance data. If the traffic zone includes a plurality of traffic spaces, e.g. a plurality of parking garages, the name of the particular parking garage can also be part of the entrance data. In addition, e.g. the parking time and/or parking fee can also be stored as data retrievable by the terminal, or further service-relevant information, such as charge rate information, parking space information and the like. The retrievable information can be stored locally or on remote communication devices.

Noncontacting data communication of the terminal with the transmitting and/or receiving devices at the, or each, entrance and exit of the traffic zone is preferably effected by a radio link. But any other form of noncontacting data communication is also applicable, for example an IR link.

Preferably, the terminal has a microchip for a radio link according to the Bluetooth™ standard with the transmitting and/or receiving devices at the, or each, entrance and exit of the traffic zone.

If a terminal with a display, in particular a mobile phone, is used, the data stored in retrievable form can be indicated on the display of the terminal or mobile phone. Instead or additionally, a voice output device can be provided as information reporting means.

For retrieval of the data the parking facility can have a central transmitting device. If the terminal used is a mobile phone, the central transmitting device can be a mobile base station. The mobile base station can be connected with a computer in which the retrievable data are stored. A personal digital assistant or similar communication device can be used instead of a mobile phone.

The entrance data are conveyed to the computer by the receiving device at the, or each, entrance of the traffic zone. Likewise, the transmitting and/or receiving device at the, or each, exit is connected with the computer for determining the parking time and/or parking fee.

With a mobile phone or similar communication device, the data can be retrieved from the computer in the form of an SMS communication or similar information. For this purpose the computer, for example a PC, can e.g. dial via a modem into a GSM gateway of the telecommunication infrastructure, which then sends the SMS communication to the mobile phone.

However, a transmitting device can also be provided at the, or each, entrance and exit for communicating with the terminal, in particular each receiving device at the, or each, entrance and exit of the traffic zone can be formed as a transmitting and receiving device for bidirectional data communication.

If an SMS communication is used for transmitting the entrance and optionally other data on a display or similar information reporting means of the terminal, a code number is preferably transmitted additionally. This prevents an SMS communication from being sent by a third party over the normal mobile network to the mobile phone used for parking, permitting the entrance and other data stored in retrievable form to be falsified and thus e.g. leading to complaints.

The SMS communication or similar information can also be transmitted not by retrieval but automatically via the transmitting and/or receiving device.

Instead of on a display, the entrance and other data can also be stored in a different form, for example in a mailbox with which the mobile phone communicates. Transmission of the transaction-related information can also be effected from the terminal to another terminal.

If a Bluetooth™ chip is used, the identification data of the terminal can be the chip number of the Bluetooth™ chip. The chip number of the Bluetooth™ chip in the terminal, for example the mobile phone, is read by the receiving device at the, or each, entrance and exit. The identification data of the data carrier may be any other type of data, however, for example in case of a mobile phone its phone number or a name or other data, for example the credit number or banking connection that have been inputted into the terminal.

To obtain parking authorization, the user can convey his identification data and further parking authorization data to the operator of the traffic zone, for example over a telecommunication device such as a telephone or the Internet. If the chip serial number of the Bluetooth™ chip in the terminal is used as identification data, this number must be known to the parking user. In this way a long-term parker can make a parking contract with the operator, for example.

Instead of being transmitted by a telecommunication device, however, the identification data, e.g. the chip number of the Bluetooth™ chip, can also be read by a manual or automatic cash register device or the like before the parking facility is entered. Also, the further parking authorization data can be stored via this device.

The further parking authorization data can be e.g. the name and address, phone number of the mobile phone used as a terminal or credit card number of the parking user or his banking connection, depending on the mode of settlement.

The identification data are stored together with the further parking authorization data in a data base that can be accessed by the abovementioned computer or PC. Also, the identification data can be stored in the terminal together with further service-relevant information. Payment of the parking fees is then ensured by positive comparison of the identification data of the terminal read by the receiving device at the exit when the traffic zone is left, with the stored identification data.

Settlement can be effected in accordance with the stored parking authorization data, i.e. via the telephone bill if the phone number is stored, via the credit card if the credit card number is stored, by debiting if the banking connection is stored, and e.g. by billing if name and address of the parking user are stored.

For settlement and user management, the phone numbers and/or credit card numbers and/or banking connection and/or names and/or address and/or further information of the persons with parking or access authorization can be stored in the computer and linked with the identification data of the terminal.

However, it is also possible to ensure payment by cash at a cash register or with a credit card before the parking facility is left.

In the following the invention will be explained in more detail by way of example with reference to the enclosed drawing, whose single figure shows schematically the entrance and exit of a parking facility with a chargeable parking system.

Accordingly, a parking facility not shown in detail, e.g. a parking garage, has parking post 2 with barrier 3 at entrance 1, and parking post 5 with barrier 6 at exit 4. In the car or similar vehicle to be parked (not shown) there is terminal 7, for example a mobile phone, having keypad 21 as a user interface and Bluetooth™ chip 8 for noncontacting data transmission with receiving devices 10, 11 provided in parking posts 2, 5 at entrance 1 and exit 4, respectively.

Receiving devices 10 and 11 of parking posts 2 and 5 are connected for data communication with computer 12, for example a PC.

If the parking facility has a plurality of entrances or exits, parking post 2, 5 is provided at each entrance or exit with barrier 3, 6 and receiving device 10, 11 connected with computer 12.

Computer 12 is formed via a transmitting device for noncontacting data communication with mobile phone 7, whereby the transmitting device can be formed by telecommunication infrastructure 20 with SMS gateways 13, which is connected for example via modem 14 with computer 12.

Mobile phone 7 has identification data that are readable with receiving devices 10 and 11, for example a unique identifier stored in chip 8, e.g. the chip serial number. Computer 12 or a data base (not shown) which it can access store the identification data, for example the chip serial numbers of mobile phones 7 and further data of the parking-authorized persons or vehicles, the further parking authorization data being provided in particular to ensure payment of the parking fee. Depending on the mode of settlement, the further parking authorization data can be for example the name and address of the parking-authorized person, his credit card or phone number or his banking connection.

For parking, the vehicle with mobile phone 7 drives toward barrier 3 at entrance 1. The identification data of mobile phone 7, for example the number of chip 8, are read there with receiving device 10 over Bluetooth™ radio 15, whereupon barrier 3 at entrance 1 is opened.

With computer 12 the identification data of mobile phone 7 and the entrance data are stored, the entrance data being at the same time stored so as to be retrievable by mobile phone 7. Thus, transmitter 12 sends SMS communication 16 from GSM gateway 13 to mobile phone 7 at entrance 1. The entrance data are thus readable on display 17 of mobile phone 7.

The entrance data are primarily the entrance time, i.e. date and time of entrance. For parking facilities with a plurality of parking garages (e.g. P1, P2, P3, P4 . . . ) and/or a plurality of entrances (e.g. floor 1, 2, 3, 4 . . . or entrance on street X, street Y, street Z . . . ), the particular garage, e.g. “P3”, and/or particular entrance, e.g. “floor 2” or “street X entrance”, can also be indicated on display 17.

When parking is over, i.e. to leave the parking facility, the vehicle drives toward barrier 6 at exit 4. The identification data of mobile phone 7, e.g. the number of chip 8, are read there with receiving device 11 by Bluetooth™ radio 18. With computer 12 the parking fee is calculated on the basis of the stored identification data and entrance and exit times.

The calculated parking fee can be stored so as to be retrievable by mobile phone 7. Thus, computer 12 sends SMS communication 19 to mobile phone 7 over GSM gateway 13. The parking fee and optionally further data, such as the exit time, are thus readable on display 17 of mobile phone 7.

Further, computer 12 checks the further stored parking authorization data that ensure settlement and thus payment of the fee accrued for the parking time.

In case of positive comparison of the stored parking authorization data with the identification data of mobile phone 7, barrier 6 at exit 4 is opened.

1. A method for chargeable or authorized parking in a traffic zone, the vehicle carrying a terminal (7) for noncontacting data communication with transmitting and/or receiving devices (10, 11, 13) and having a user interface (21) with at least two keys and information reporting means, identification data being received from the terminal (7) by a receiving device or transmitting and receiving device (10) at the entrance (1) to the traffic zone, the blocking device (3) at the entrance (1) being opened after reception of the identification data, the identification data being received at the exit (4) by a receiving device or transmitting and receiving device (11) when the traffic zone is left, and the blocking device (6) at the exit (4) being opened in case of ensured payment of the fee accrued for the parking process or of authorization, characterized in that the identification data are stored in the terminal (7) so as to be readable by the receiving device or transmitting and receiving device (10, 11) at the entrance (1) and the exit (4), and the entrance data and/or parking time and/or charge rate information and/or parking space information and/or further service-relevant information are transmitted to the terminal (7) over a telecommunication infrastructure (20) or the transmitting and receiving device (10, 11).

2. A method according to claim 1, characterized in that a radio or IR link is used for data communication of the terminal (7) with the transmitting and/or receiving devices (10, 11, 13).

3. A method according to claim 2, characterized in that the terminal (7) used is a terminal with a device (8) for a radio link according to the Bluetooth™ standard with the transmitting and/or receiving devices (10, 13).

4. A method according to any of the above claims, characterized in that the terminal (7) conveys to the user the data stored in retrievable form with the information reporting means.

5. A method according to any of the above claims, characterized in that the terminal (7) used is a mobile phone, a personal digital assistant or similar communication device.

6. A method according to any of the above claims, characterized in that an SMS communication or similar information is transmitted to the terminal (7) over the telecommunication infrastructure (20) or the transmitting and receiving device (10, 11).

7. A method according to claim 6, characterized in that the SMS communication or similar information is transmitted to the terminal (7) over the telecommunication infrastructure (20) or the transmitting and receiving device (10, 11) upon retrieval or automatically.

8. A method according to any of the above claims, characterized in that a code number or similar signature is transmitted as an additional security feature together with the SMS communication or similar information.

9. A method according to any of the above claims, characterized in that the identification data of the terminal (7) used are a unique identifier stored in the terminal (7).

10. A method according to any of the above claims, characterized in that the terminal used is a mobile phone (7) and the identification data are the mobile phone number.

11. A method according to any of the above claims, characterized in that the terminal (7) used is a Bluetooth™-capable terminal and the identification data are a unique Bluetooth™ chip serial number.

12. A method according to any of the above claims, characterized in that payment is ensured by positive comparison of the identification data of the terminal (7) read by the receiving device (11) when the traffic zone is left, with the stored identification data.

13. A method according to any of the above claims, characterized in that the phone numbers and/or credit card number and/or banking connection and/or names and/or address and/or further information of the persons with parking or access authorization are stored in the computer (12) and linked with the identification data of the terminal (7) for settlement and user management.

14. A method according to any of the above claims, characterized in that payment is effected with credit card, bank direct debit authorization or via another payment system linked with the terminal (7).

15. A method according to any of the above claims, characterized in that the transaction-related information is transmitted from the terminal (7) to a different terminal to continue the process with a different terminal.

16. A system for carrying out the method according to any of the above claims, characterized in that the receiving device or transmitting and receiving device (10) at the entrance (1) and the receiving device or transmitting and receiving device (11) at the exit (4) are formed for data communication with a computer (12), and the identification data are stored in the terminal (7) so as to be readable by the receiving devices or transmitting and receiving devices (10, 11).

17. A system according to claim 16, characterized in that a telecommunication infrastructure (20) connected with the computer (12) is provided for transmitting the entrance data and/or parking time and/or charge rate information and/or parking space information and/or further service-relevant information to the terminal (7).
